(19) United States
(12) Patent Application Publication
(10) Pub. No.: US 2011/0193492 A1
(43) Pub. Date: Aug. 11, 2011

(54) LIGHT-EMITTING DIODE LIGHTING DEVICE

(75) Inventor: CHIN-LUNG LIN, TAIPEI CITY 111 (TW)

(73) Assignee: UNISTAR OPTO CORPORATION, TAIPEI (TW)

(21) Appl. No.: 12/900,697

(22) Filed: Oct. 8, 2010

(30) Foreign Application Priority Data
Feb. 11, 2010 (TW) 099203047

(51) Int. Cl. H05B 37/02

(52) U.S. Cl. 315/294; 315/291

(57) ABSTRACT

A light-emitting diode (LED) lighting device includes at least a base, at least an LED light source, and at least a driver. The LED light source is of a rectangular parallelepiped form and is directly mounted to and packaged on an outer surface of the base. The driver is electrically connected to the LED light source for driving the LED light source to emit light.

### BACKGROUND OF THE INVENTION

1. Field of the Invention

The present invention relates to a lighting device, and in particular to a lighting device that comprises a light source formed by directly mounting and packaging a light-emitting diode on an outer surface thereof.

2. The Related Arts

Traditional fluorescent lighting is commonly used, but there is much to be improved for the fluorescent lighting. For example, a fluorescent lighting device comprises a connector for holding a fluorescent tube and such a connector often suffers material embrittlement due to high temperature after being in service for a long time. Further, the connector may be damaged due to replacement of fluorescent tube. As to the power supply, each set of fluorescent lighting requires its own power supply device and serial connection of several fluorescent tubes may lead to overloading in voltage, eventually causing danger of operation. In the respect of cost, the fluorescent lighting requires power cables of large gauge and the fluorescent tube is of short lifespan, both leading to an increase of cost for using fluorescent lighting.

In view of these problems, the present invention aims to provide a lighting device that is advantageous in reducing power consumption and lowering costs in order to overcome the problems.

### SUMMARY OF THE INVENTION

A primary objective of the present invention is to provide a light-emitting diode (LED) lighting device, which comprises an LED that is directly mounted to and packaged on an outer surface of a base to serve as a light source. Since no connector is needed for the light source, there is of no concern of material embrittlement of the connector. Further, voltage and current of the electricity flowing through power cables of the LED lighting device are low so that the risk of operation danger can be reduced and power consumption also reduced. Further, the LED has a lifespan that is longer than that of the fluorescent tubes, so that the material cost is reduced and the inconvenience of replacing lighting tube is lowered.

To achieve the above objective, the present invention provides an LED lighting device, which comprises at least a base, at least an LED light source, and at least a driver. The LED light source is of a rectangular parallelepiped form and is directly mounted to and packaged on an outer surface of the base. The driver is electrically connected to the LED light source for driving the LED light source to emit light.

The effectiveness of the LED lighting device of the present invention is that through direct packaging of an LED light source on a base, safety of operation, reduction of power consumption, extension of product lifespan, and reduction of manufacturing cost are realized.

### BRIEF DESCRIPTION OF THE DRAWINGS

The present invention will be apparent to those skilled in the art by reading the following description of a preferred embodiment thereof, with reference to the attached drawings, wherein:

FIG. 1 is a perspective view showing a light-emitting diode (LED) lighting device constructed in accordance with a preferred embodiment of the present invention;

FIG. 2 is an exploded view of the LED lighting device in accordance with the preferred embodiment of the present invention; and

FIG. 3 is an enlarged view of the circled portion indicted by reference A in FIG. 2.

### DETAILED DESCRIPTION OF THE PREFERRED EMBODIMENT

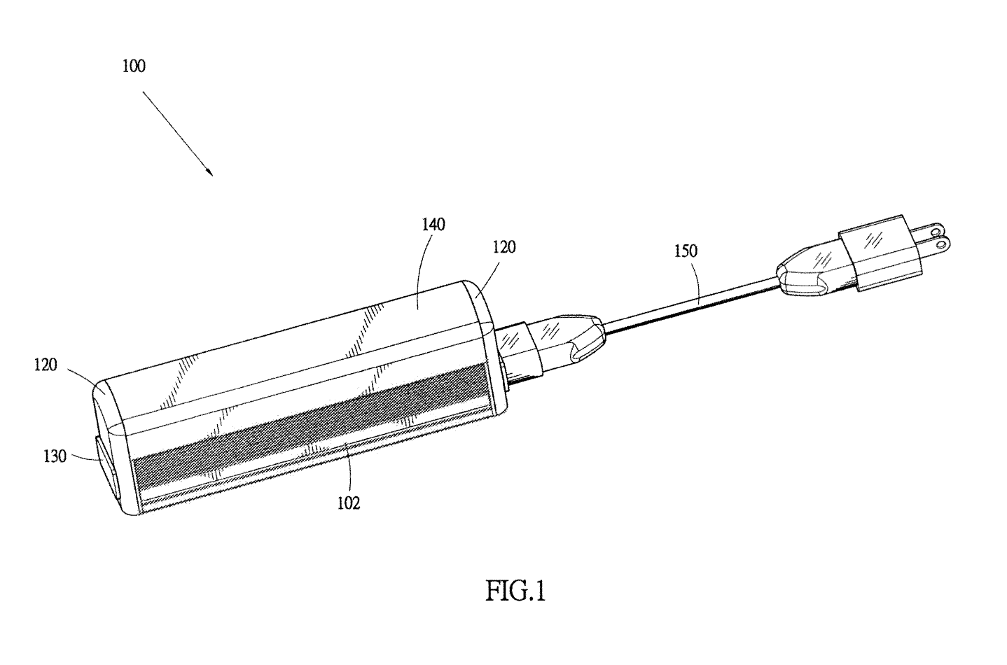

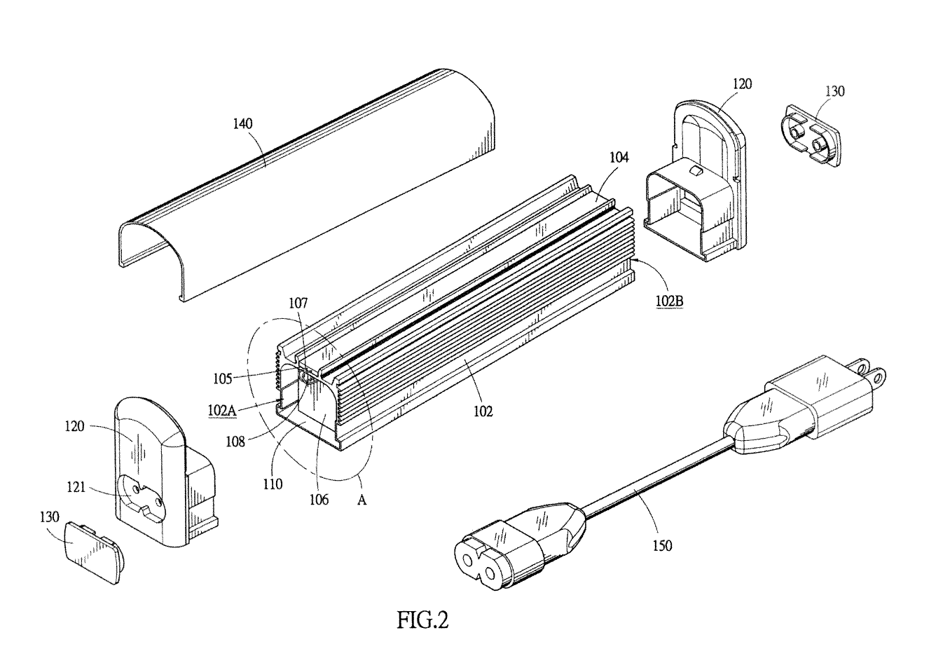

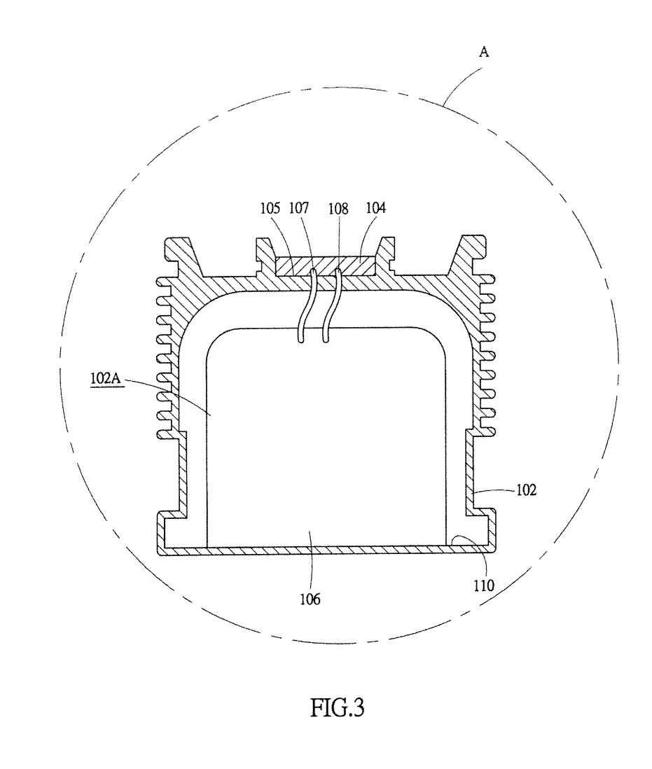

With reference to the drawings and in particular to FIGS. 1-3, which respectively show a perspective view, an exploded view, and an enlarged cross-sectional view of a light-emitting diode (LED) lighting device constructed in accordance with a preferred embodiment of the present invention, generally designated at 100, the LED lighting device 100 as shown in the drawings is embodied as ceiling-mounted or wall-mounted lighting. The LED lighting device 100 comprises at least a base 102, at least an LED light source 104, and at least a driver 106. The base 102 can be made of a metal, a ceramic material or Plastics, and in the instant embodiment, the base 102 is made of an aluminum based material showing high thermal conductivity. The base 102 has an outer surface 105, which in the instant embodiment is on a top of the base 102, and an inner surface 110.

The LED light source 104 is preferably of a rectangular parallelepiped form, but is not limited to any specific form or shape. In the instant embodiment, a single multi-die LED module is taken as an example of the LED light source 104. In the packaging process of the LED light source 104, the LED light source 104 is directly mounted to and packaged on the outer surface 105 of the base 102, whereby the LED light source 104 and the base 102 are integrated together as a unitary structure. In this way, the base 102 can serve as a heat dissipation structure of the LED light source 104.

The driver 106 is mounted on the inner surface 110 of the base 102. The driver 106 comprises at least two power output terminals 107, 108 through which the driver 106 is electrically connected to the LED light source 104, whereby the driver 106 may selectively drive the LED light source 104 to emit light. The LED light source 104 is covered by a light-transmitting shade 140 that is mounted to the top of the base 102. The light-transmitting shade 140 functions to adjust the distribution of light and protect the LED lighting device 100 against invasion of dirt and dust.

The base 102 has two opposite open ends 102A, 102B, which are respectively covered and closed by end lids 120. Each end lid 120 forms at least one external power socket 121. The driver 106 has power input terminals that are electrically connected to the power socket 121, whereby the driver 106 of the LED lighting device 100 may be connected to an external power source, such as electric main, or other power sources through the power socket 121. For example, a power cable 150 can be provided to electrically connect the power socket 121 to the electric main, or several power cables 150 are provided to serially connect between multiple LED lighting devices 100, whereby electricity can be supplied, in both cases, to the driver(s) 106. Preferably, a dust-proof cover 130 is provided to cover the power socket 121, when the power socket 121 is not in use.

To summarize, the LED lighting device 100 of the present invention provides the following advantages:

(1) The base 102 and the LED light source 104 are integrally combined together as a unitary device, so that the manufacturing is simplified and material embrittlement of connector is no longer of concern for no electrical connector is needed between the two.

(2) The LED light source 104 is integrally combined with the base 102 through the packaging thereof, so that the base 102 may directly serve as a heat dissipater for the LED light source 104 and no additional heat dissipation structure, which requires consumption of additional heat dissipative material, is needed and consequently, cost for manufacturing the additional heat dissipation structure and material used to manufacture the additional heat dissipation structure can both be saved.

(3) The voltage and current of the electricity flowing through the power cables or power connections are reduced, making them less dangerous and providing enhanced expandability as compared to the conventional fluorescent lighting.

(4) The LED light source 104 has a smaller volume than fluorescent lighting and also possesses longer lifespan and lower rate of malfunctioning.

(5) The LED light source 104 has a power factor greater than that of fluorescent lighting and thus consumes less power than the fluorescent lighting.

(6) The conventional fluorescent lighting requires frequent replacement of fluorescent tubes and ballasts, but the LED lighting device 100 provided by the present invention uses no lighting tubes and ballasts, so that there is no concern of replacement of lighting tubes and ballasts for the present invention.

(7) Although the LED light source 104 has a unit price higher than that of the conventional fluorescent lighting, yet due to the cost saving for electricity consumption and maintenance realized by the LED lighting device 100 of the present invention, the annual electricity cost and maintenance expense of the LED light source 104 of the present invention are lower than those of the conventional fluorescent tube and associated lighting devices. Consequently, the present invention is of better performance in energy saving as compared to the conventional lighting.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A light-emitting diode (LED) lighting device, comprising;
at least a base;
at least an Chip on Board (COB) LED light source, which is mounted to and package on an outer surface of the base; and
at least a driver, which is electrically connected to the LED light source for driving the LED light source to emit light.

2. The LED lighting device as claimed in claim 1, wherein the base is made of metal.

3. lighting device as claimed in claim 1, wherein the base is made of ceramic.

4. The LED lighting device as claimed in claim 1, wherein the base is made of Plastics.

5. The LED lighting device as claimed in claim 1, wherein the base is made of an aluminum based material showing heat conductivity.

6. The LED lighting device as claimed in claim 1, wherein the base has two ends respectively closed by end lids.

7. The LED lighting device as claimed in 6, wherein each of the end lids forms a power socket.

8. The LED lighting device as claimed in 7, further comprising a power cable connected to the power socket of at least one of the end lids.

9. The LED lighting device as claimed in claim 7, wherein the power socket of at least one of the end lids is covered by a dust-proof cover.

10. LED lighting device as claimed in claim 1 further comprising a light-transmitting shade mounted to the base to cover the LED light source.

11. The LED lighting device as claimed in claim 1, wherein the LED light source has a rectangular parallelepiped form.

12. The LED lighting device as claimed in claim 1, wherein the LED light source comprises a multi-die LED module.

13. The LED lighting device as claimed in claim 1, wherein the base has an outer surface on which the LED light source is mounted and packaged.

14. The LED lighting device as claimed in claim 1, wherein the base has an inner surface to which the driver is mounted.
